(19) United States
(12) Patent Application Publication
(10) Pub. No.: US 2005/0016567 A1
(43) Pub. Date: Jan. 27, 2005

(54) Substrate treatment apparatus

(75) Inventors: Ho-Min Kang, Sunwon-city (KR); Jin-Su Kim, Asan-city (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD.

(21) Appl. No.: 10/872,319

(22) Filed: Jun. 18, 2004

(30) Foreign Application Priority Data
Jun. 19, 2003 (KR) 10-2003-0039708

(51) Int. Cl. B08B 3/04

(52) U.S. Cl. 134/66; 134/151

(57) ABSTRACT

A substrate treatment apparatus for transferring a substrate in a horizontal direction and supplying a process solution to a surface of the substrate is provided, which includes: a substrate support unit holding the substrate thereunder; a shower unit for supplying the process solution, the shower unit placed under the substrate and spaced apart from the substrate; and a transfer unit for transferring the substrate support unit 10 in the horizontal direction.

### BACKGROUND OF THE INVENTION

(a) Field of the Invention

The present invention relates to a substrate treatment apparatus, and particularly to a transfer type substrate treatment apparatus for a liquid crystal display.

(b) Description of Related Art

A liquid crystal display (“LCD”) is manufactured by repetitive chemical processes such as developing, etching, cleaning, etc. performed on a surface of a glass substrate. The manufacturing apparatuses are classified into dry type and wet type, and the wet type apparatuses are classified into batch type and single type. The single type apparatuses are classified into rotation type and transfer type such as roller transfer.

Among the above process apparatuses, the transfer type apparatus transfers a substrate in a substantially horizontal direction and supplies a process solution, which is highly effective and popular for etching.

In a transfer type substrate process apparatus, an etching solution is injected from a plurality of spray nozzles arranged in matrix over a substrate transfer line to the entire surface of a substrate which is transferred during the injection of the etching solution. Then, the surface of the substrate is etched selectively by a shower process except the portion on which a masking material is applied. When the etching is finished, a shower cleaning process is performed subsequently.

In general, the substrate is transferred in horizontal state when the process solution is injected or the substrate is washed in the etching and cleaning process of an LCD. As the size of the substrate goes larger, substrate inclination transfer is sometimes used to make up for the large size.

The recent tendency is that the size of the substrate increases rapidly, but the horizontal or inclination type is not enough for preventing the problems like poor uniformity, stain, attachment of foreign material, and so on.

In other words, when etching and/or cleaning process, i.e. wet process, is performed in the conventional horizontal or inclination state for a large substrate, a large amount of process solution or cleaning solution is present, but the process solution or cleaning solution injected from the above is not reached effectively to various portions of the substrate, which causes poor process performance.

Whirling phenomenon and flowing to a specific direction of the process solution are generated on several portions of the substrate to cause stains.

Residue generated from another process or foreign material is remained on the substrate and adsorbed on the substrate again during wet process.

A fluid transfer prevention apparatus such as air knife, etc. used for preventing the process solution from flowing to the edge of the substrate may not be effective for every portion of the substrate when the substrate becomes larger, and another problem that a large amount of air or a complicated instrument is needed is occurred.

### SUMMARY OF THE INVENTION

A substrate treatment apparatus for transferring a substrate in a horizontal direction and supplying a process solution to a surface of the substrate is provided, which includes: a substrate support unit holding the substrate thereunder; a shower unit for supplying the process solution, the shower unit placed under the substrate and spaced apart from the substrate; and a transfer unit for transferring the substrate support unit 10 in the horizontal direction.

The shower unit may inject the process solution in a vertical direction.

The substrate support unit supports the substrate using electrostatic force, vacuum pressure, or clamping.

### BRIEF DESCRIPTION OF THE DRAWINGS

The present invention will become more apparent by describing embodiments thereof in detail with reference to the accompanying drawings in which:

FIG. 1 is a lateral view of a substrate process apparatus according to a first embodiment of the present invention;

FIG. 2 is a layout view of a substrate process apparatus according to the first embodiment of the present invention;

FIG. 3 is a lateral view of a substrate process apparatus according to a second embodiment of the present invention; and

FIG. 4 is a lateral view of a substrate process apparatus according to a third embodiment of the present invention.

### DETAILED DESCRIPTION OF EMBODIMENTS

The present invention is directed to provide a substrate process apparatus which improves poor process performance and uniformity due to a large amount of process solution or cleaning solution.

The present invention now will be described more fully hereinafter with reference to the accompanying drawings, in which preferred embodiments of the inventions invention are shown. The present invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Now, preferred embodiments of the present invention will be described in detail with reference to the accompanying drawings.

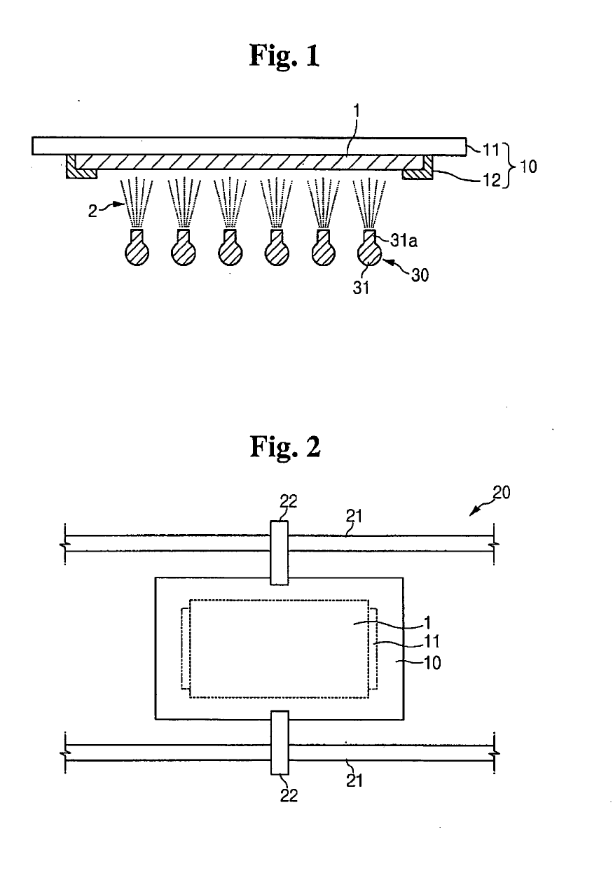

Referring FIGS. 1 and 2, a substrate process apparatus according to a first embodiment of the present invention includes a substrate support unit 10 under which a substrate 1 is attached, a shower unit 30 placed under the substrate 1 with a specified distance apart, and a transfer unit 20 for transferring the substrate support unit 10 in a horizontal direction.

The substrate support unit 10 holds the substrate 1 under the substrate support unit 10 by clamping. As shown in FIG. 1, the substrate support unit 10 includes a supporter 11 for supporting the substrate 1 and a damper 12 arranged under the bottom surface of the supporter 11 and attached to the side of the substrate 1 to fix the substrate 1.

As shown in FIG. 2, the transfer unit 20 which transfers the substrate support unit 10 includes a pair of guide rails 21 and a pair or arms 22. An end portion of each of the pair of arms 22 is attached to the side of the supporter 11 of the substrate support unit 10, and the other end portion is connected to the guide rails 21. The arms move along the guide rails 21, thereby moving the substrate support unit 10 connected to the arms 22. Therefore, the substrate 1 attached to the bottom surface of the substrate support unit 10 by the damper 12 moves.

A shower unit 30 is placed under the substrate 1 with a specified distance apart. A plurality of spray nozzles 31 of the shower unit 30 injects the process solution 2 to the substrate 1. That is, injection holes 31a of the spray nozzles 31 face up and inject the process solution 2 to the substrate 1, which is placed over the spray nozzle 21.

The substrate process apparatus according to the first embodiment of the present invention transfers the substrate 1 in a horizontal direction and supplies the process solution 2 to the surface of the substrate 1.

In other words, the substrate support unit 10 connected to the transfer unit 20 is transferred and the shower unit 30 placed thereunder injects the process solution 2 to wet process the substrate 1.

Since the process solution 2 is injected upward, process solution or cleaning solution cannot be remained on the substrate 1 even though a large amount of the process or cleaning solution is injected. Therefore, wet process can be performed using a relatively small amount of the process or cleaning solution and low fluid pressure, thereby improving process performance of etching etc. and cleaning performance.

In addition, uniformity of etching or cleaning is improved because uniform wet process can be made over the entire substrate 1.

Since there is no process or cleaning solution remained on the substrate 1 due to the perpendicular injection of the process solution 2, the substrate 1 can be transferred to the next process step with out any residue or foreign material which might be generated during substrate process or cleaning. Therefore, cleanness of the substrate 1 is improved.

Since there is no process or cleaning solution remained on the substrate 1 due to the perpendicular injection of the process solution 2, liquid transfer prevention apparatus such as air knife, etc. used for preventing the process solution from flowing to the edge of the substrate is not needed or can be replaced with a simple apparatus.

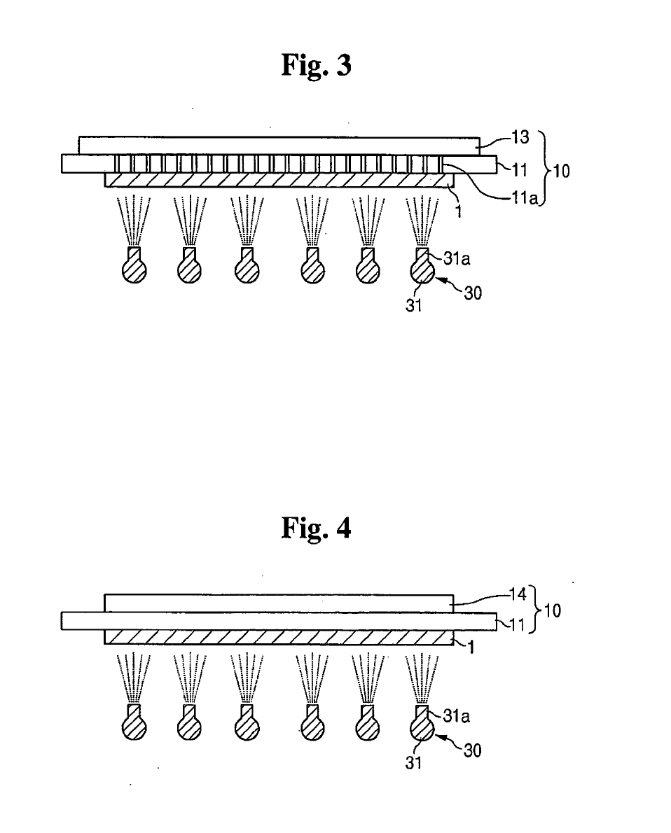

FIG. 3 shows a substrate process apparatus according to a second embodiment of the present invention. Same reference numerals as the drawings mentioned above indicate the same parts for performing the same function.

As shown in FIG. 3, a substrate process apparatus according to a second embodiment of the present invention includes a substrate support unit 10 under which a substrate 1 is attached, a shower unit 30 placed under the substrate 1 with a specified distance apart, and a transfer unit 20 for transferring the substrate support unit 10 in a horizontal direction.

The substrate support unit 10 supports the substrate 1 by vacuum pressure. The substrate support unit 10 includes a supporter 11 having vacuum holes 11a for supporting the substrate 1 and a vacuum generator 13 connected to the supporter 11. The vacuum pressure generated by the vacuum generator 13 applied to a surface of the substrate through the vacuum holes 11a, and therefore, the substrate 1 is adsorbed by the vacuum pressure.

The substrate process apparatus according to the second embodiment of the present invention has almost the same constitution and effect as the first embodiment except the method of supporting the substrate. That is, the substrate process apparatus according to the second embodiment of the present invention transfers the substrate 1 in a horizontal direction and supplies the process solution 2 to the surface of the substrate 1. The substrate support unit 10 which is connected to the transfer unit 20 and where the substrate 1 is attached by vacuum pressure method is transferred and the shower unit 30 placed thereunder injects the process solution 2 to wet process the substrate 1.

FIG. 4 shows a substrate process apparatus according to a third embodiment of the present invention. Same reference numerals as the drawings mentioned above indicate the same parts for performing the same function.

As shown in FIG. 4, a substrate process apparatus according to a third embodiment of the present invention includes a substrate support unit 10 under which a substrate 1 is attached, a shower unit 30 placed under the substrate 1 with a specified distance apart, and a transfer unit 20 for transferring the substrate support unit 10 in a horizontal direction.

The substrate support unit 10 supports the substrate 1 using electrostatic force. The substrate support unit 10 includes a supporter 11 for supporting the substrate 1 and an electrostatic force generator 14 connected to the supporter 11. The substrate (glass substrate) 1 is attached to the supporter due to electrostatic force generated by the electrostatic force generator 14. Since surface area of the substrate is large and the substrate is a glass substrate in which electrostatic force can be generated easily, the substrate can be attached well to the supporter 11 by the electrostatic force.

The substrate process apparatus according to the third embodiment of the present invention has almost the same constitution and effect as the first embodiment except the method of supporting the substrate. That is, the substrate process apparatus according to the third embodiment of the present invention transfers the substrate 1 in a horizontal direction and supplies the process solution 2 to the surface of the substrate 1. The substrate support unit 10 which is connected to the transfer unit 20 and where the substrate 1 is attached by electrostatic force is transferred and the shower unit 30 placed thereunder injects the process solution 2 to wet process the substrate 1.

On the other hand, the substrate process apparatus according to the first through third embodiments of the present invention can be adapted to dry process before or after wet process or wet pre-process (UV, AP plasma, Air Cleaning, etc.) as well as wet process. That is, the substrate 1 is transferred hanging upside down, and absorption of particles generated during conventional process and dropped down to the substrate 1 can be prevented.

Also, the substrate process apparatus according to the first through third embodiments of the present invention can be adapted to dry etching process to prevent particles generated during dry etching process and dropped down from absorbing on the surface of the substrate 1.

According to the present invention, since the injection direction of the process solution is perpendicular, process solution or cleaning solution cannot be remained on the substrate even though a large amount of the process or cleaning solution is injected. Therefore, wet process can be performed using a relatively small amount of the process or cleaning solution and low fluid pressure.

In addition, uniformity of etching or cleaning is improved because uniform wet process can be made over the entire substrate.

Since there is no process or cleaning solution remained on the substrate due to the upward perpendicular injection of the process solution, the substrate can be transferred to the next process step with out any residue or foreign material which might be generated during substrate process or cleaning. Therefore, cleanness of the substrate is improved.

Since there is no process or cleaning solution remained on the substrate due to the perpendicular injection of the process solution, liquid transfer prevention apparatus such as air knife, etc. used for preventing the process solution from flowing to the edge of the substrate is not needed or can be replaced with a simple apparatus.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A substrate treatment apparatus for transferring a substrate in a horizontal direction and supplying a process solution to a surface of the substrate, comprising:
a substrate support unit holding the substrate thereunder;
a shower unit for supplying the process solution, the shower unit placed under the substrate and spaced apart from the substrate; and
a transfer unit for transferring the substrate support unit 10 in the horizontal direction.

2. The substrate treatment apparatus of claim 1, wherein the shower unit injects the process solution in a vertical direction.

3. The substrate treatment apparatus of claim 1, wherein the substrate support unit supports the substrate using electrostatic force.

4. The substrate treatment apparatus of claim 1, wherein the substrate support unit supports the substrate using vacuum pressure.

5. The substrate treatment apparatus of claim 1, wherein the substrate support unit supports the substrate using clamping.
